(19) United States
(12) Patent Application Publication
(10) Pub. No.: US 2010/0138359 A1
(43) Pub. Date: Jun. 3, 2010

(54) SYSTEM AND METHOD FOR FACILITATING BUSINESS & INSURANCE AND/OR ESTATE PLANNING

(76) Inventor: David R. Alter, Fairfield, NJ (US)

Correspondence Address: CONNOLLY BOVE LODGE & HUTZ, LLP, P O BOX 2207, WILMINGTON, DE, 19899, US

(21) Appl. No.: 12/546,919

(22) Filed: Aug. 25, 2009

Related U.S. Application Data
(60) Provisional application No. 61/190,028, filed on Aug. 25, 2008.

(51) Int. Cl. G06Q 40/00

(52) U.S. Cl. 705/36 R

(57) ABSTRACT

A tangible computer-readable medium having stored thereon, computer-executable instructions that, if executed by a system, cause the system to perform a method including: receiving information indicative of a plurality of financial related plans; receiving information indicative of a plurality of future events; and presenting a visual matrix including additional information about each of the plurality of financial plans, based at least in part upon a product of a probability of at least one of the plurality of future events occurring and a return of each of the financial related plans if the at least one of the future events occurs.

### CROSS REFERENCE TO RELATED APPLICATION

This application claims priority of U.S. patent application Ser. Nos. 61/190,028 entitled: System and Method for Facilitating Business, Insurance and/or Estate Planning, filed Aug. 25, 2008, having common inventor David R. Alter; and which is incorporated herein by reference as if set forth in its entirety herein.

### FIELD OF THE INVENTION

Embodiments of the present invention relate to business, insurance, and/or estate planning.

### SUMMARY OF EMBODIMENTS OF THE INVENTION

A tangible computer-readable medium having stored thereon, computer-executable instructions that, if executed by a system, cause the system to perform a method including: receiving information indicative of a plurality of financial related plans; receiving information indicative of a plurality of future events; and presenting a visual matrix including additional information about each of the plurality of financial plans, based at least in part upon a product of a probability of at least one of the plurality of future events occurring and a return of each of the financial related plans if the at least one of the future events occurs.

A method for aiding financial planning, including: inputting information indicative of a plurality of financial related plans to a computing system; inputting information indicative of a plurality of future events to a computing system; and providing a visual matrix including additional information about each of the plurality of financial plans, based at least in part upon a product of a probability of at least one of the plurality of future events occurring and a return of each of the financial related plans if the at least one of the future events occurs.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and in which:

FIGS. 1-7 illustrate embodiments of an interface according to certain embodiments of the present invention;

FIGS. 8-16 illustrate embodiments of decision grids or matrices according to certain embodiments of the present invention;

FIG. 17 illustrates mortality data that may be used in certain embodiments of the present invention; and,

FIGS. 18 and 19 illustrate a decision grid or matrix according to an embodiment of the present invention.

### DESCRIPTION OF THE PREFERRED EMBODIMENTS OF THE INVENTION

It is to be understood the figures and descriptions of the present invention have been simplified to illustrate elements that are relevant for understanding the present invention, while eliminating, for purposes of clarity, many other elements found in typical computing and planning systems and methods. Because such elements are well known in the art, and because they do not facilitate a better understanding of the present invention, a discussion of such elements is not provided herein.

A system and method for facilitating business, insurance and/or estate planning is provided by certain embodiments of the present invention. Embodiments of the present invention may take the form of an integrated business, insurance, and estate planning and selling system. Such a system may be particularly useful for utilization by life insurance agents and other professionals in the financial services industry. Because of its underlying mathematical and logical principles, embodiments of the present invention may enable these professionals to: 1) create actual value, as measured by Expected Return, for clients utilizing the planning system and its underlying tools; 2) allow users to make correct financial decisions with a higher degree of certainty; and/or 3) obtain higher client satisfaction, closing ratios, and increased compensation due to the success of their selling efforts.

Embodiments of the present invention may be well suited to support financial services industry professionals in the following markets: 1) high family income (minimum gross family income of $250,000 to $350,000 in the NY Metropolitan area—it may be lower or higher in other sections of the country); 2) businesses (minimum annual sales of $2,000,000 in the NY Metropolitan area—it may be lower or higher in other sections of the country); and/or 3) high net worth families (minimum family assets of $2,000,000 in the NY Metropolitan area—it may be lower or higher in other sections of the country).

For non-limiting purposes of explanation only, the financial services industry, as used herein, generally includes all the disciplines which advise or potentially advise clients with respect to business, insurance, and estate planning. It may include: 1) life insurance agents and brokers; 2) general insurance agents and brokers; 3) certified public accountants; 4) trust, estate, tax, and commercial attorneys; 5) investment brokers; 6) investment bankers; 7) investment advisors; 8) benefits consultants; and/or 9) business advisors.

At present, there is no broadly accepted standard as to what constitutes correct business, insurance and estate planning within the financial services industry. Embodiments of the present invention utilize a unique approach founded in the mathematical principle of Expected Return to this area of the financial services industry in order to scientifically set a standard approach. Embodiments of the present invention are different than other business, insurance, and estate planning and selling tools in that, for example: 1) they consider the broad range of potential future life events in order to maximize Expected Return; 2) in business situations, they use the planning process to increase the value of business interests to the owners; 3) they utilize tables as so-called “decision grids” to model on a simple, understandable, and meaningful basis how to make the best planning decision; 4) they prove that traditional rate of return analysis under a linear outcome (a linear outcome assumes the potential future outcome is known) mis-overstates rate of return as a decision tool because it (traditional rate of return analysis) fails to take into account the differing probabilities of alternative outcomes; 5) maximizes Expected Return to clients by applying integrated legal, administrative, and risk management tools with insurance products; 6) benefit clients through the context of a proprietary interview and selling process based upon logical decision principles applied in the context of on-site consumer meetings; and/or maximize the likelihood of a plan being agreed to by and between multiple parties in planning situations. The great majority of planning situations are, in fact, multiparty, e.g. husband and wife, parent and child, owner and executive(s), multiple owners, outside professional advisors, etc.

“Expected Return—Simple” and “Expected Return including Present Value” are underlying principles employed by embodiments of the present invention. Embodiments of the present invention apply these approaches to business, insurance, and estate planning and selling in the form of the decision grids.

Embodiments of the present invention use a mathematically-based logical approach and develop plans that focuses on the broad range of foreseeable outcomes in an individual(s), family's, or business owner(s) life. With the use of embodiments of the present invention, client(s) and/or advisor(s) can establish what the best recommendation/decision is for the client in his/her particular situation with an improved chance of it actually being implemented relative to traditional approaches.

In certain embodiments of the present invention, an Expected Return Formula (Simple) is utilized to explain and illustrate how to make a financial decision to a client. After the presentation to the client, a mathematical-based solution illustrates that a plan that works under a range of foreseeable circumstances is generally better than a plan that works under more limited circumstances.

In certain embodiments of the present invention, an Expected Return Formula (including Present Value) is utilized. This tool has the same purpose as the Expected Return Formula (Simple), except it includes it discounts the Expected Return to a Present Value of the Expected Return.

In certain embodiments of the present invention, a decision grid (Individual) table or matrix tool is utilized. This tool may be based upon the Expected Return mathematical formulas listed above. This tool may illustrate a range of foreseeable possible outcomes that could occur in an individual(s)'s, business owner(s)'s, or others persons'/entities' life or future. The decision grid tool can be used to: 1) develop an appropriate plan; 2) compare alternate plans or recommendations; 3) determine which alternate plan or recommendation is, in fact, the best. In certain embodiments of the present invention the decision grid tool serves as an interactive computer based tool that can be available for printing and hardcopy usage. It may be available in generic and customized versions. The customized versions may use a series of simple pre-formatted questions to pre-populate the result indicators, sometimes referred to as outcome boxes. In certain embodiments of the present invention, each outcome box can be customized using drop down type inputs. In certain embodiments of the present invention, decision grids may become marked up and used as a worksheet. In certain embodiments of the present invention, decision grids will provide flexibility as to: 1) use of quantitative, qualitative, logical, or yes/no/maybe, or textual inputs; 2) the ability to vary the total number of outcome boxes in a particular decision grid; 3) the ability to customize outcome boxes; 4) the ability to mix and match the inputs between quantitative, qualitative, logical, yes/no/maybe, or textual in nature. In certain embodiments of the present invention, decision grids (Business) may be used as a tool that has the same purpose and design attributes as the decision grid (Individual), except it includes standardized outcome boxes more appropriate for consideration in business situations. In certain embodiments of the present invention, a Life Expectancy Comparator tool provides a method of modeling probability and life expectancy to optimize Expected Return in planning situations.

The following describes a non-limiting embodiment of the present invention used to deliver a plan design.

An introduction and commitment meeting may be held. The objective of an introduction & commitment meeting is to establish a working relationship with the client(s) using a system according to an embodiment of the present invention. In this meeting the financial services professional can follow a corresponding training script and use a corresponding Power Point presentation. The script and presentation may be designed to be executed in the instructed order to increase the likelihood of the prospect(s) becoming a client(s).

A fact finding meeting may be held. The objective of a fact finding meeting is to obtain all the required facts, objectives, field underwriting needed to allow the plan to be delivered efficiently, quickly, and with the best results for the client. The financial services professional can use a tool to collect all of the pertinent information in order to obtain the correct facts and objectives of the case necessary to properly use the other tools in the system.

A preliminary presentation may be made. The objective of a preliminary presentation is to present preliminary facts and concepts. This meeting may not follow a rigid format, due to the individuality of each case. At this meeting the financial services professional may discuss and/or use the following with the prospect/client: 1) an embodiment of the present invention decision grids - customized to the prospect/clients particular situation; 2) an embodiment of a value maximization system toolkit; and 3) a Life Expectancy Comparator table. The goal of using these resources may be to accomplish the following for the financial services professional and the prospect/client: 1) clearly defined objectives; 2) accurate facts; 3) client interaction and direction for plan development; 4) development and implementation of a plan that works under a range of foreseeable circumstances.

A recommendations meeting may be held. The objective of a recommendations meeting is to present a final plan and obtain client agreement to proceed. At this meeting the financial services professional may present to the prospect/client the following: 1) a proposal packet; 2) a term Sheet (customized outline); 3) decision grids (customized); 4) final insurance proposals and insurance modeling; and a 5) toolkit. After presenting this to the prospect/client, the financial services professional may finalize the aforementioned items and have the client complete all relevant documents and signature pages.

A follow through meeting may be held. The objective of a follow through meeting is to oversee the successful implementation of all action items and to work with the other advisors involved to ensure that all documents and recommendations have been implemented. It should be understood that this stage is overlooked in many planning and selling systems. Once the prospect/client has agreed to purchase products from and/or pay the fee to the financial services professional, most professionals do not follow through on the remaining documents, paperwork, etc. That is one (albeit not the only) reason why less than 5% of the target markets described earlier have fully executed business, insurance, and/or estate plans.

Throughout the following examples the financial services professional can choose which type of client he/she would like to work with. Some examples of selectable options include “Personal” and “Business” clients. In certain embodiments of the present invention the only difference between the “Business” decision grid and the “Personal” decision grid is the different outcome boxes. Both the “Personal” decision grid and the “Business” decision grid may have the same capabilities, and the option to add more outcome boxes and to print.

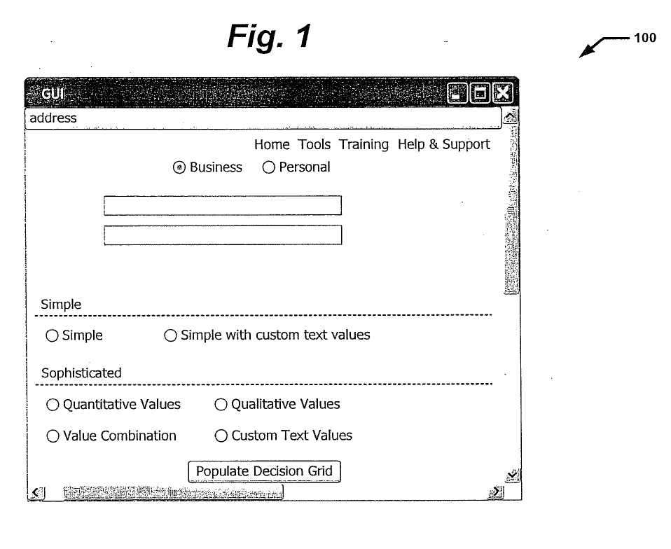

Referring now to FIG. 1, there is shown a user interface, such as a web page, screen or interface 100 for a decision grid application according to an embodiment of the present invention. A financial services professional can gain access to the decision grid application, or decision grid, by accessing a corresponding website, local area network, virtual server, or local computer, for example. In the illustrated embodiment of the figures, the screens/interfaces take the form of conventional windows, such as those corresponding to instantiations of a web browser application, for example. Other applications and/or approaches, such as a conventional application, as opposed to a thin-application, may be used though.

In certain embodiments of the present invention, once a financial services professional has logged into the website, they have multiple options to choose from. The exemplary illustration and corresponding descriptions of decision grids correspond to a non-limiting embodiment of the present invention well suited for use by a financial services professional. In the illustrated example of FIG. 1, screen or interface 100 allows a financial professional to enter information, such as the type of client the professional is working with, name(s) of the client(s) and type or style of decision grid desired for use. In certain embodiments of the present invention, once selections are made and/or data entered using interface 100, data indicative of the entries may be stored in memory, and later recalled for automatic population on other screens, for example.

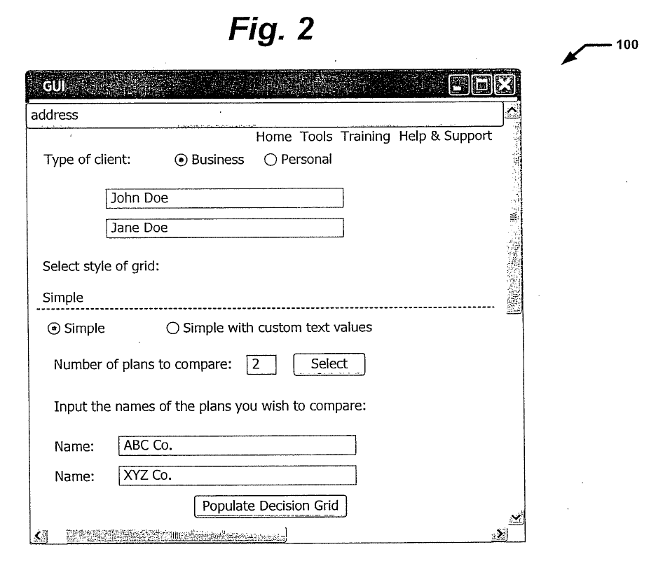

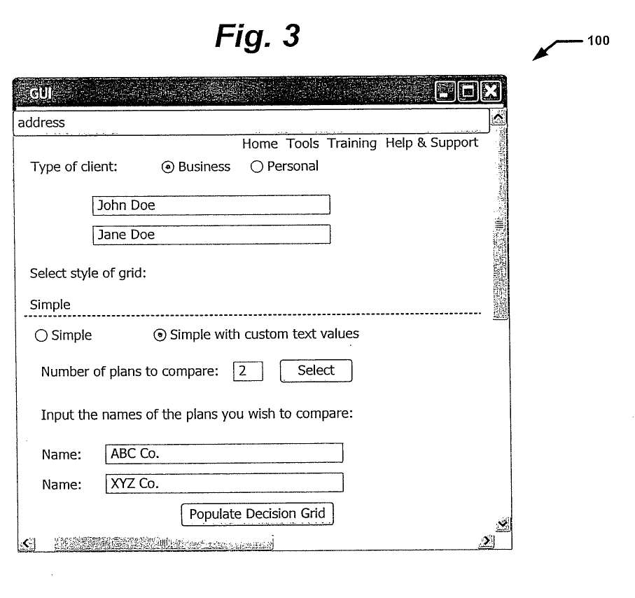

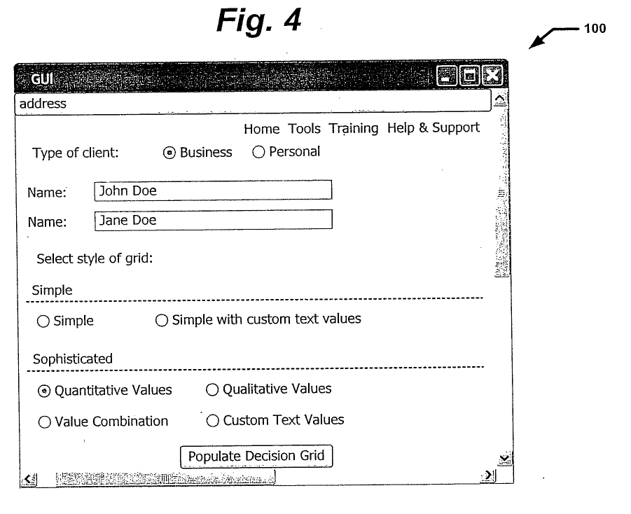

Referring now also to FIG. 2, for example, activation of a “simple” style decision grid may result in the system prompting the user/professional for additional information, such as the number of plans to compare, and the names of those plans, in the illustrated embodiment. A similar result occurs responsively to user/professional selection of the “simple with custom text values” style, as is shown in FIG. 3. Other styles, such as “quantitative values”, “qualitative values”, “custom text values” and “value combination” styles may also be selected, as are shown in FIGS. 4-7.

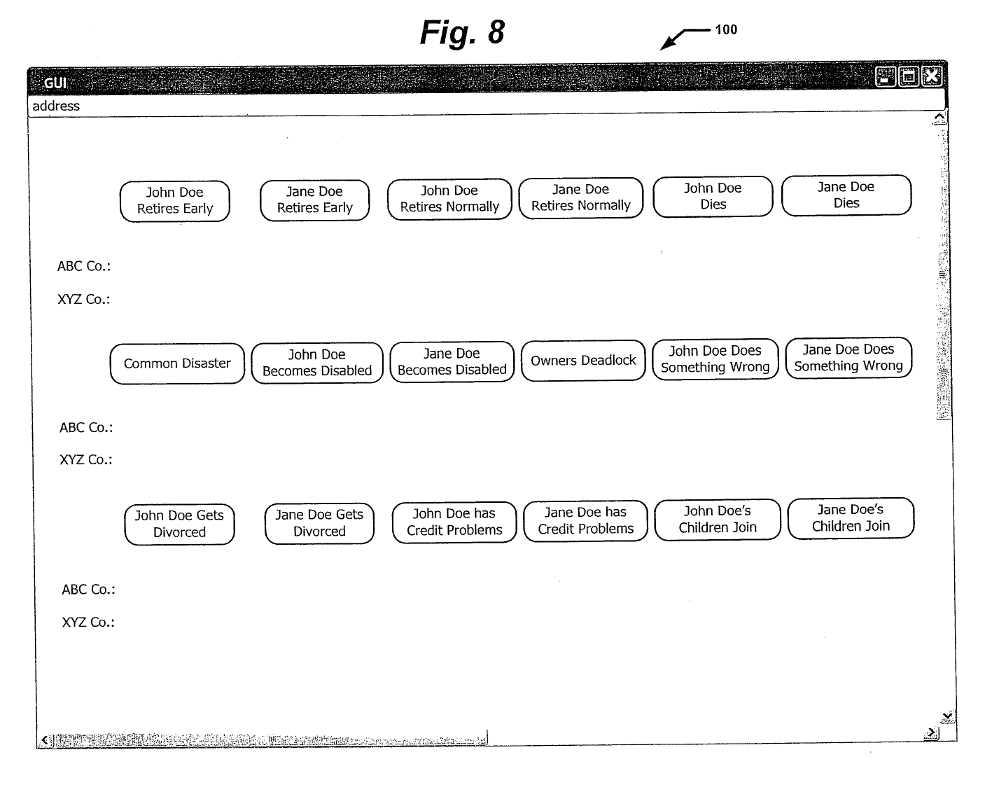

Referring still to FIGS. 1-7, interface 100 additionally includes a “Populate Decision Grid” button, activation of which causes the system to display a decision grid ready to be used by the financial services professional, such as that shown in FIG. 8.

The financial services professional can then go through his/her presentation with the aid of such a grid, or matrix. For example, in the illustrated embodiment of FIG. 8 he/she may-compare the ABCs Co. and XYZ Co. plans. Each outcome box (some of which have been populated with each business owner's name) is a different outcome that could occur in the business owners professional and personal lives that could affect or alter the business relationship between the owners. The outcome boxes may be automatically populated in certain embodiments, such as certain embodiments of a simple style decision grid, based upon the information entered using interface 100 and predefined outcomes stored in a database corresponding to the information entered using interface 100.

In certain embodiments of the present invention, a financial services professional has multiple options to have a desired icon appear as he/she goes through each outcome in the matrix or grid. The options may include:

Entry Method #1—As the financial services professional clicks with their mouse under each outcome box and to the right of the desired plan (in the matrix or grid) one of four icons will appear. The following icons may be used.
a. Green Check Mark—the outcome works beneficially under the current or proposed plan. The financial services professional clicks their mouse-once for this to appear.
b. Red X—the outcome does not work beneficially under the current or proposed plan. The financial services professional clicks their mouse twice for this to appear.
c. Blue Question Mark—it is uncertain if the outcome works beneficially under the current or proposed plan. The financial services professional clicks their mouse three times for this to appear.
d. If the financial services professional wants to leave a field blank and already has a symbol, he/she may click on the desired field one more time after the Blue Question Mark and the field will appear blank.

Entry Method #2—As the financial services professional navigates his/her pointer, such as via a mouse or touch screen, under the desired outcome box, five colored boxes may appear. A green, red, blue, blank, and a text box will appear and the financial services professional will select the desired box, which corresponds to the icons described above, to have the desired icon appear.

Entry Method #3—The financial services professional may choose a value for the Future Return and the Probability. The value for the Expected Return may then automatically default. This option may be well suited o a Sophisticated Style—“Qualitative” decision grid, as discussed below.

Entry Method #4—Logical multiplier.

Entry Method #5—Textual description

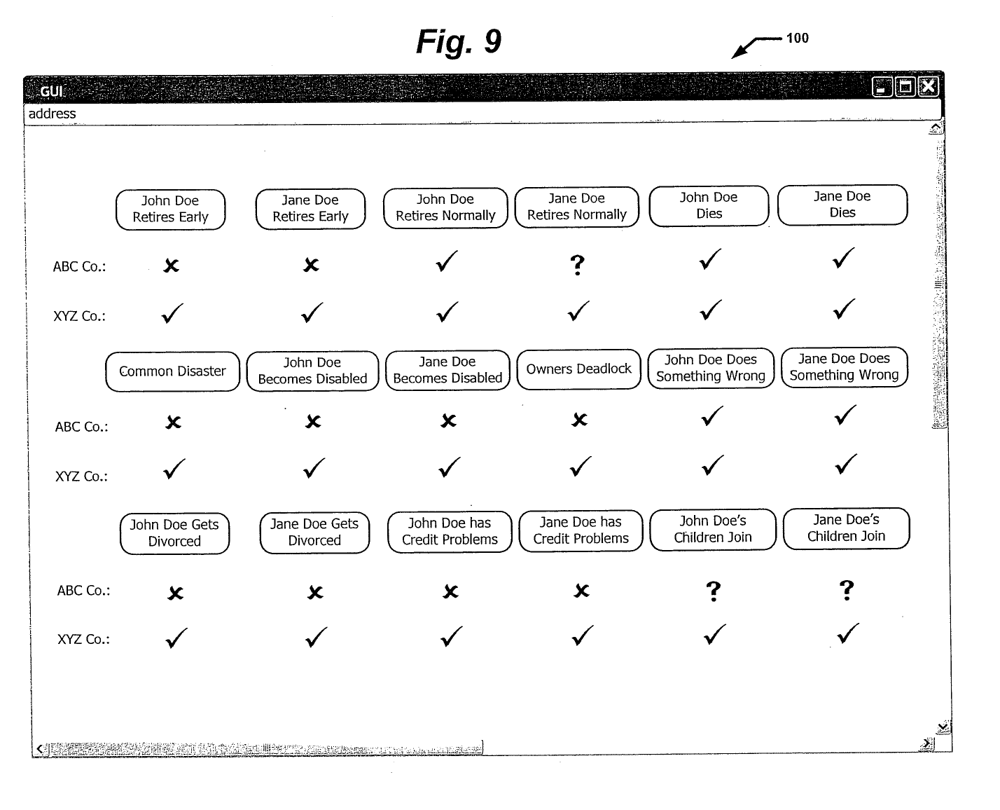

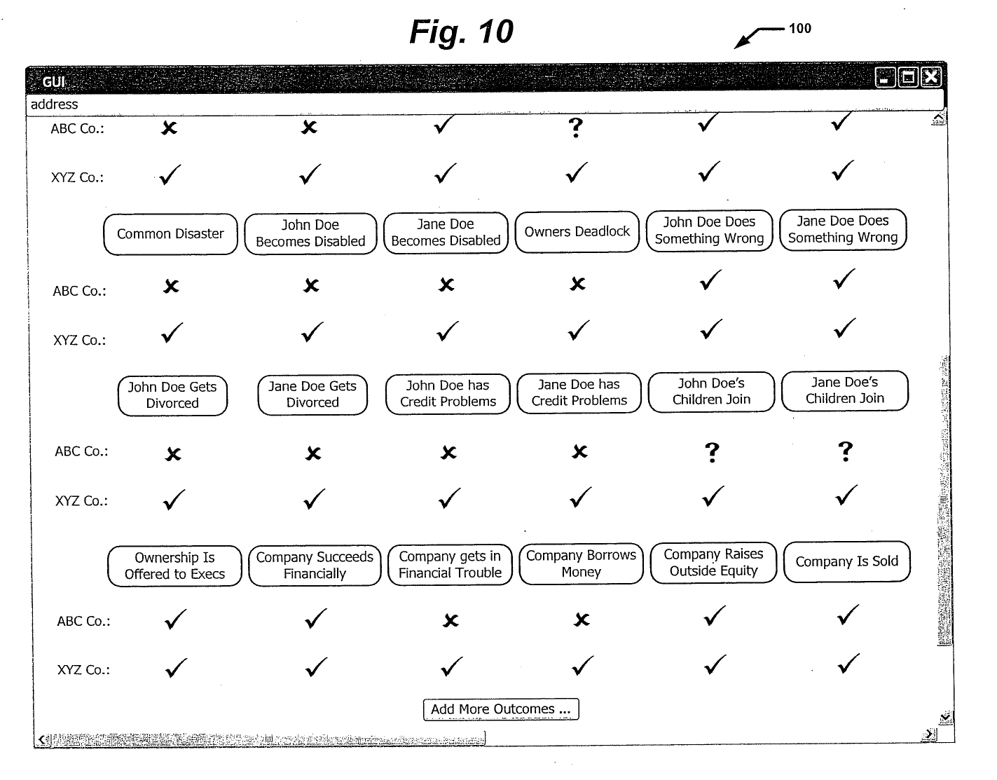

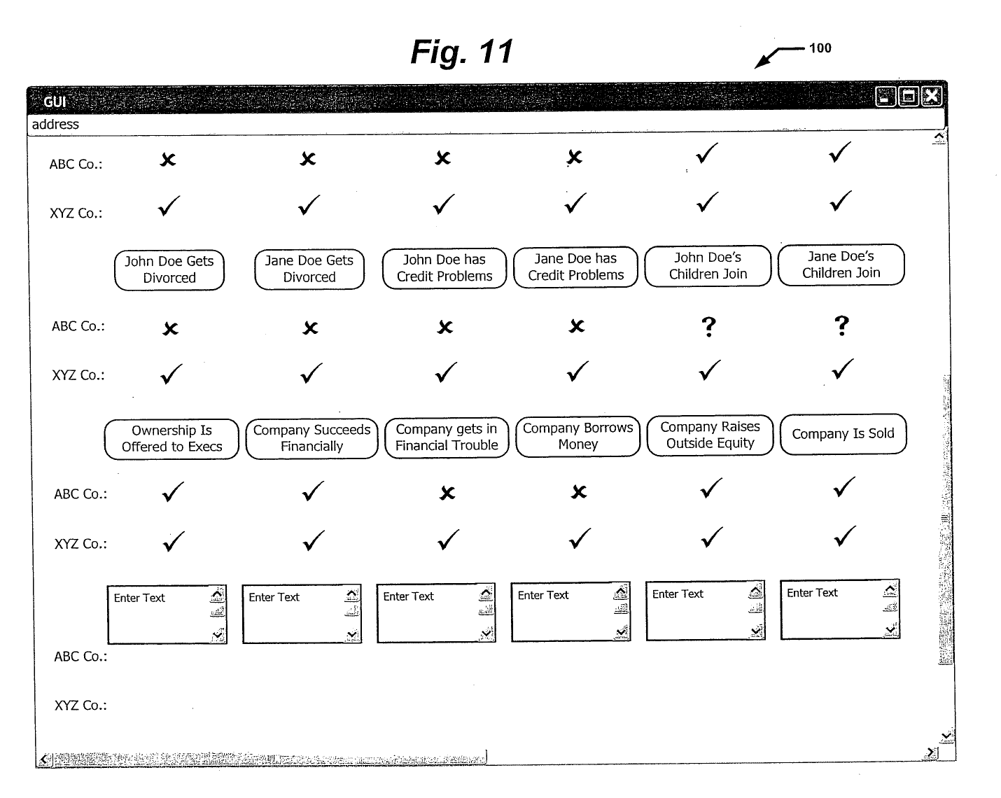

Referring now also to FIGS. 9 and 10, there is shown certain embodiments of the grid or matrix of the interface 100 of FIG. 8 with additional information displayed therein (FIG. 10 shows a scrolled-down version of FIG. 9, for example). After going through the entire decision grid, the financial services professional may have the option to add additional outcome boxes by clicking on the “Add More Outcomes” button. Referring now also to FIG. 11, activating the add more outcomes button may provide a user an opportunity to enter their own “custom” outcomes scenarios, and the result of each plan, as was described above.

In certain embodiments of the present invention, the decision grid, table or matrix may be printed on a one page or multiple page report that can be given to the client, such as by being included in a proposal packet, etc.

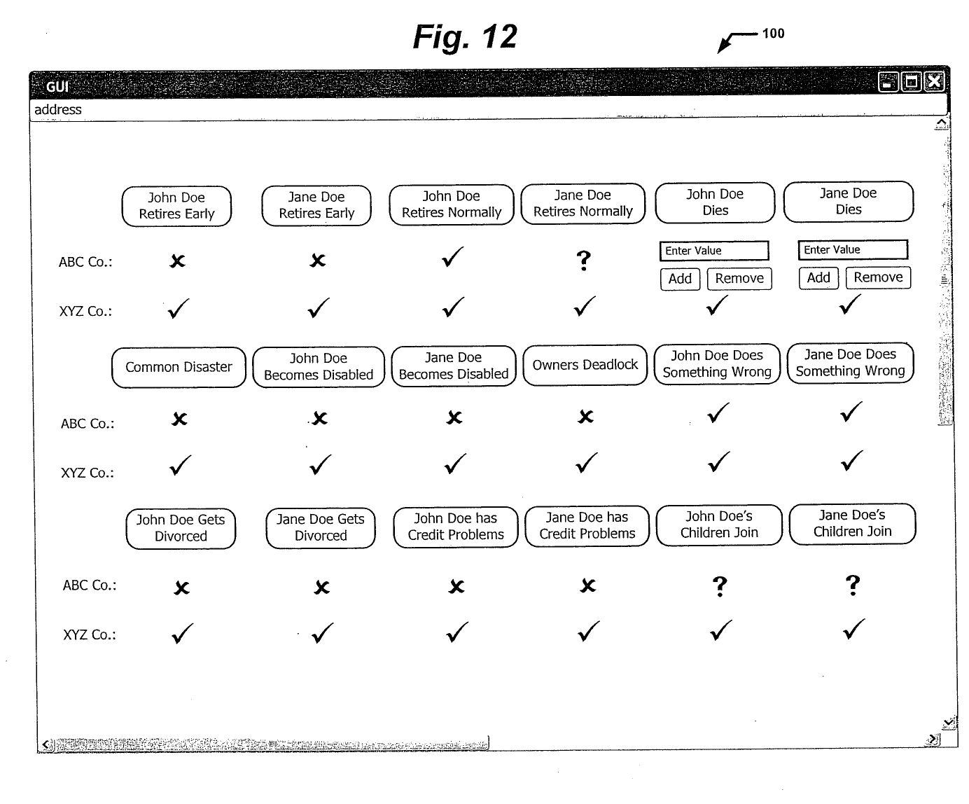

Referring again to FIG. 3, a financial services professional may follow an analogous process as previously explained in order for a “simple with custom text values”-style decision grid to be populated for use. Referring now to FIG. 12, there is shown an decision grid or matrix interface 100 well suited for use with the simple-with custom text values—style grid. Using such a style allows for text, numeric, statistical and/or other information to be conveyed as part of the grid or matrix.

To use the custom text value box, the financial services professional can enter outcome options as described above. The financial services professional may have analogous options-of adding additional outcome boxes and/or printing the decision grid as explained above.

Referring again to FIG. 1, for example, the following examples describe different options of decision grids under the Sophisticated Style. There may be four options to choose from in this style: 1) “Quantitative Values;” 2) “Qualitative Values;” 3) “Value Combination;” and 4) “Custom Text Values.”

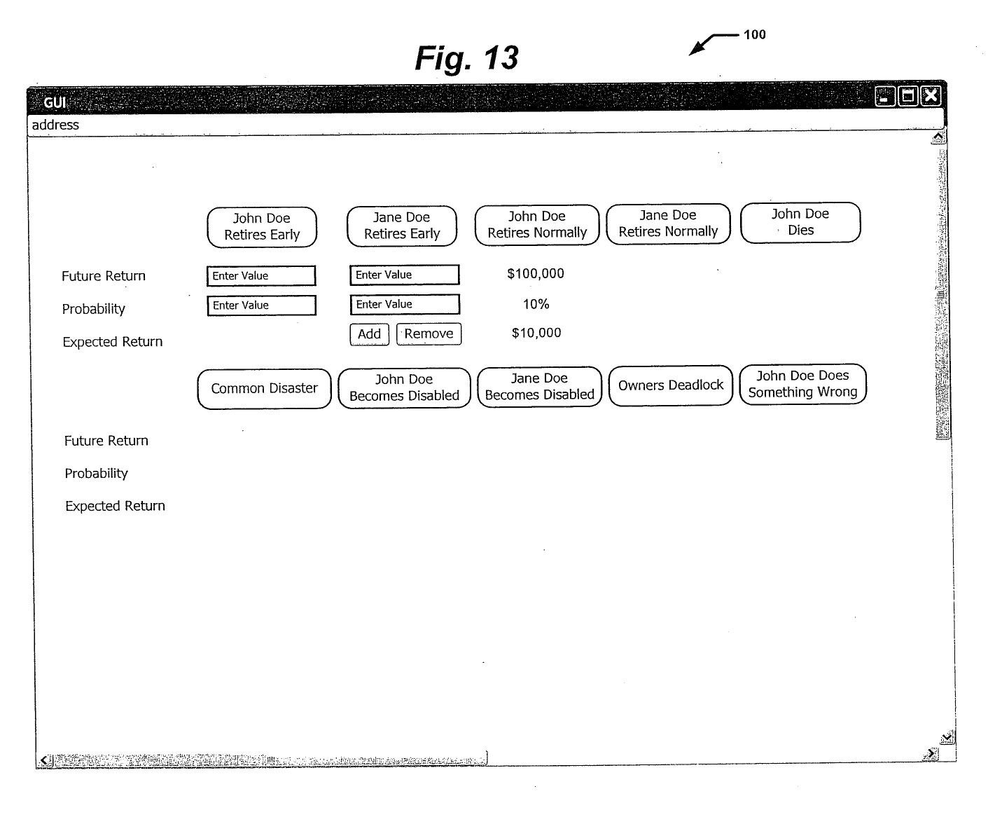

Referring now again to FIG. 4, a financial services professional may follow an analogous process as previously explained in order for a “sophisticated—quantitative values”—style decision grid to be populated for use. Referring now to FIG. 13, in such a case, instead of comparing companies or advisors, along the left hand side of the decision grid interface 100 is an expected return indication. In the illustrated embodiment, the indication includes future return, probability and expected return. Such an indication allows a financial services professional to mathematically demonstrate outcomes, and how they relate to an overall plan.

By way of non-limiting example, “expected return” as used herein generally refers to a return on an uncertain investment calculated by weighting the gains or losses by a probability that they will occur.

Referring still to FIG. 13, in certain embodiments of the present invention, a user such as a financial services professional, may select or click on a desired field under an outcome box he/she wishes to populate. A control, such as a text or numerical entry box, may be provided for the user to enter each value. When the user enters suitable values, such as numerical values, into the boxes for example, appropriate automatic calculations may be used to complete the various outcome scenarios in an expected return fashion, such as to provide a future return value. In certain embodiments of the present invention, when the user activates a button, such as an “add” button, analogous calculations may be used to complete the various outcome scenarios in an expected return fashion. In certain embodiments of the present invention, when the user activates a button, such as an “remove” button, calculated values may be removed.

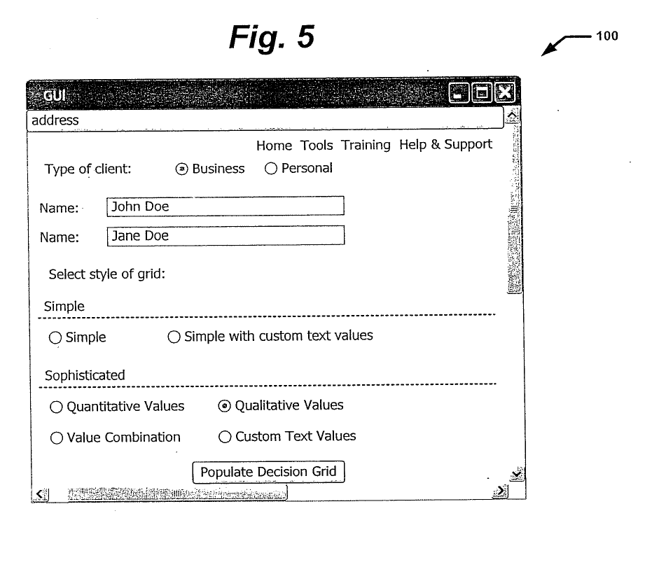

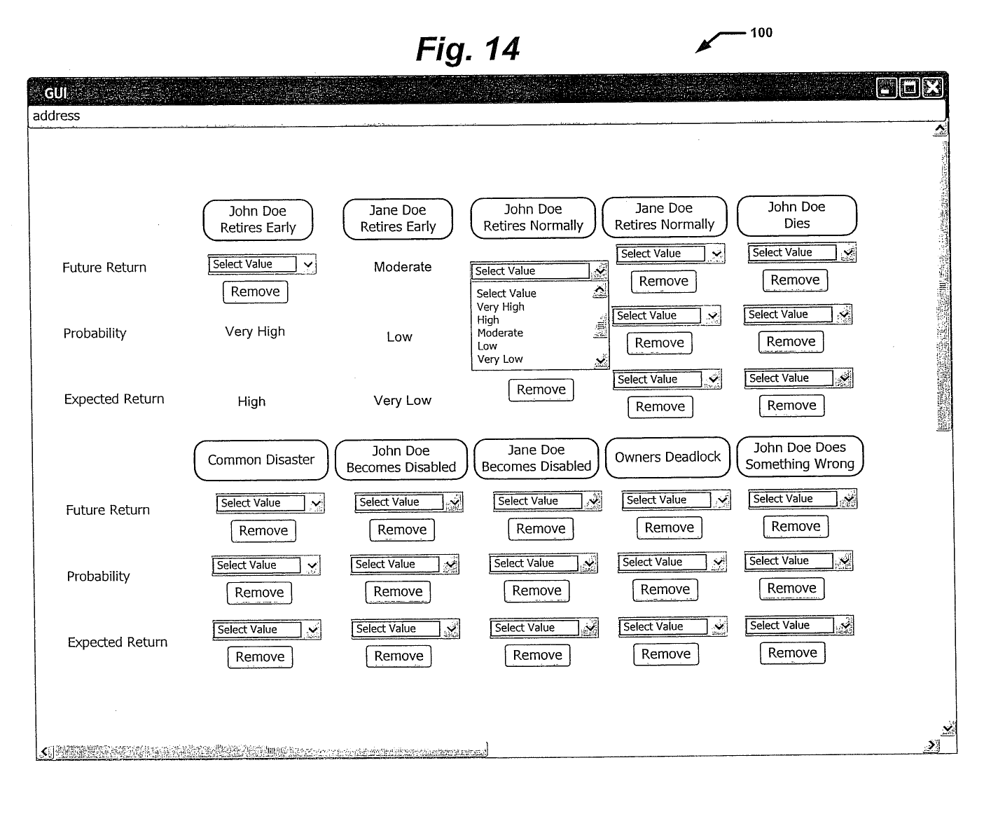

Referring now again to FIG. 5, a financial services professional may follow an analogous process as previously explained in order for a “sophisticated—qualitative values”—style decision grid to be populated for use. Referring now to FIG. 14, there is shown an embodiment of such a decision grid interface 100. Again, instead of comparing companies or advisors, along the left hand side of the decision grid interface 100 is an expected return indication. In the illustrated embodiment, the indication includes future return, probability and expected return. Such an indication allows a financial services professional to mathematically demonstrate outcomes, and how they relate to an overall plan.

The illustrated embodiment of FIG. 14 includes a plurality of selectable qualitative values. In order to have a drop down menu appear, a financial services professional may simply click on the field underneath the outcome box and to the right of the Future Return, Probability, and/or Expected Return. After-they click on the field and a drop down control appears, then the financial services professional may click on the arrow to choose from one of the presented options, e.g., very high, high, moderate, low, very low, 0 or negative, for example. Once they select and click on the desired value it will appear in the field. In certain embodiments, automatic calculations may again be used based upon the selected values to populate additional fields.

To remove a value, the financial services professional may again click on the value. Once they click on the value the drop down control may appear again. Then, he/she can simply click the “Remove” button to remove the entered value.

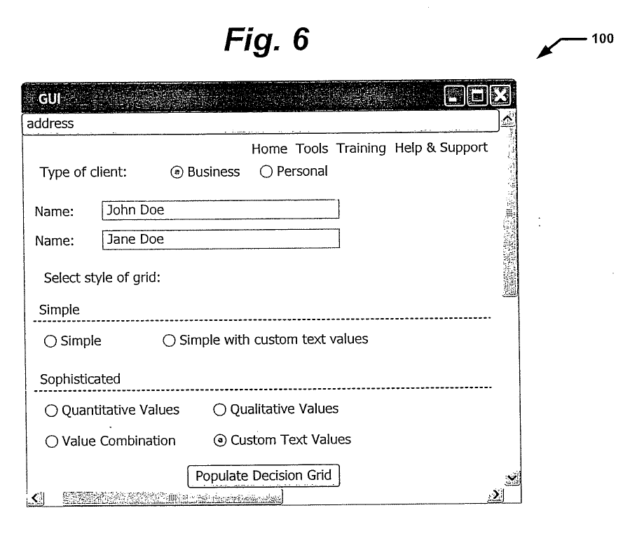

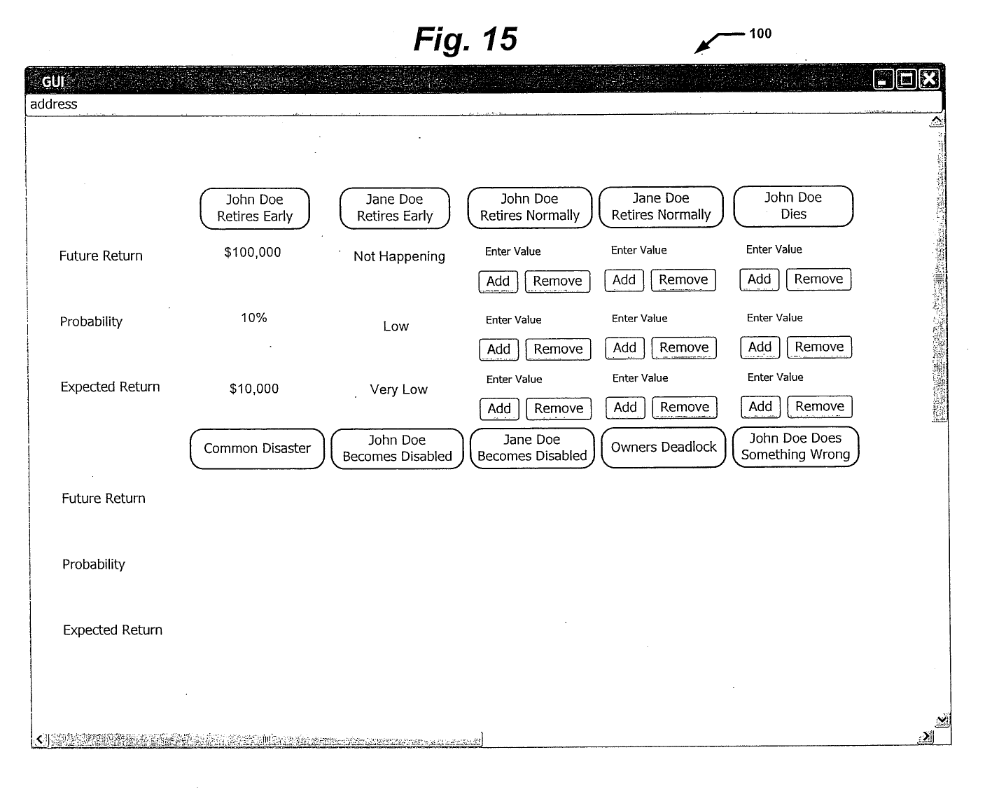

Referring now again to FIG. 6, a financial services professional may follow an analogous process as previously explained in order for a “sophisticated—custom values”-style decision grid to be populated for use. Referring now to FIG. 15, there is shown an embodiment of such a decision grid interface 100. Again, instead of comparing companies or advisors, along the left hand side of the decision grid interface 100 is an expected return indication. In the illustrated embodiment, the indication includes future return, probability and expected return. Such an indication allows a financial services professional to mathematically demonstrate outcomes, and how they relate to an overall plan.

The illustrated embodiment of FIG. 15 includes a plurality of selectable text (e.g., alphabetic, iconic, numeric, or alphanumeric) values. In order to have the text menu bar to appear, the financial services professional may simply click on or otherwise activate a field underneath an outcome box and to the right of the Future Return, Probability, and/or Expected Return. After they click on or otherwise activate the field, and once a text menu bar appears, then the financial services professional may enter the information. Again, to remove the value, the financial services professional may again click on the value. Once they click on the value the drop down control may appear again. Then, he/she can simply click the “Remove” button to remove the entered value.

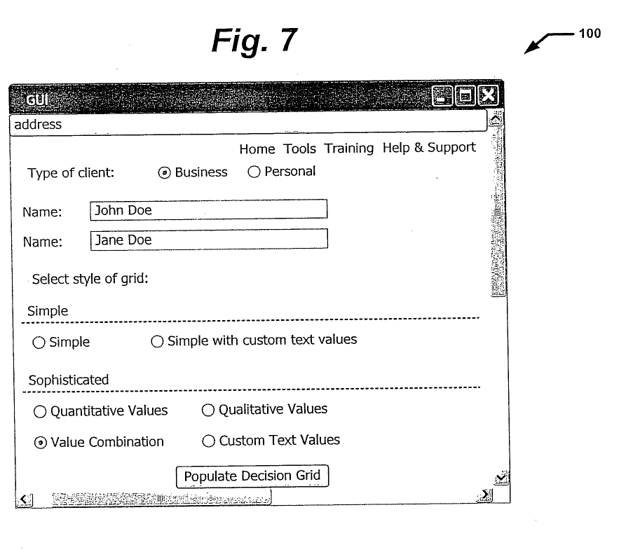

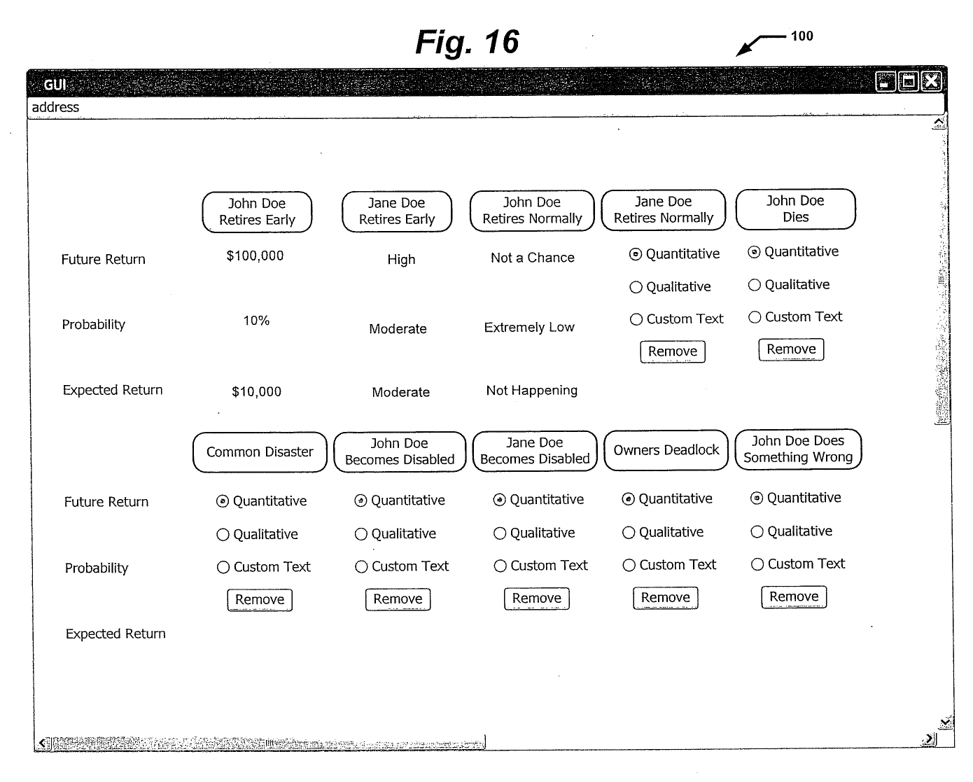

Referring now again to FIG. 7, a financial services professional may follow an analogous process as previously explained in order for a “value combination” -style decision grid to be populated for use. Referring now to FIG. 16, there is shown an embodiment of such a decision grid interface 100. Again, instead of comparing companies or advisors, along the left hand side of the decision grid interface 100 is an expected return indication. In the illustrated embodiment, the indication includes future return, probability and expected return. Such an indication allows a financial services professional to effectively demonstrate outcomes, and how they relate to an overall plan.

The illustrated embodiment of FIG. 16 allows a user, such as a financial services professional, to choose from the other sophisticated styles, to present a decision grid that includes a combination of the elements thereof. The illustrated embodiment of FIG. 16 includes quantitative, qualitative and custom text value elements. By selecting a radio button corresponding to the type of element to use for each outcome, such a grid or matrix may be fashioned.

The following non-limiting example illustrates how an embodiment of the present invention provides important information as the basis for decision making, and how alternative planning options/decisions may be used to facilitate determining a plan of action in the consumer's best interest.

This non-limiting example assumes a husband's age of 60, and a wife's age of 58. It is assumed the family net worth/gross estate is $20,000,000. It is assumed that illiquid assets are $15,000,000, and liquid assets/securities are $5,000,000.

The traditional approach by a financial services professional would be to insure the couple for $6,000,000 of Second to Die Life Insurance (insurance is only payable after the death of both spouses), owned in one irrevocable insurance trust, based upon the following analysis:

| | |
|---|---|
| Gross Estate | $20,000,000 |
| Estate Tax | $(11,000,000) |
| Securities | $5,000,000 |
| Insurance Needed | $6,000,000 |

Such a traditional analysis is believed to inaccurately reflect real-world considerations though—and improvements can be shown.

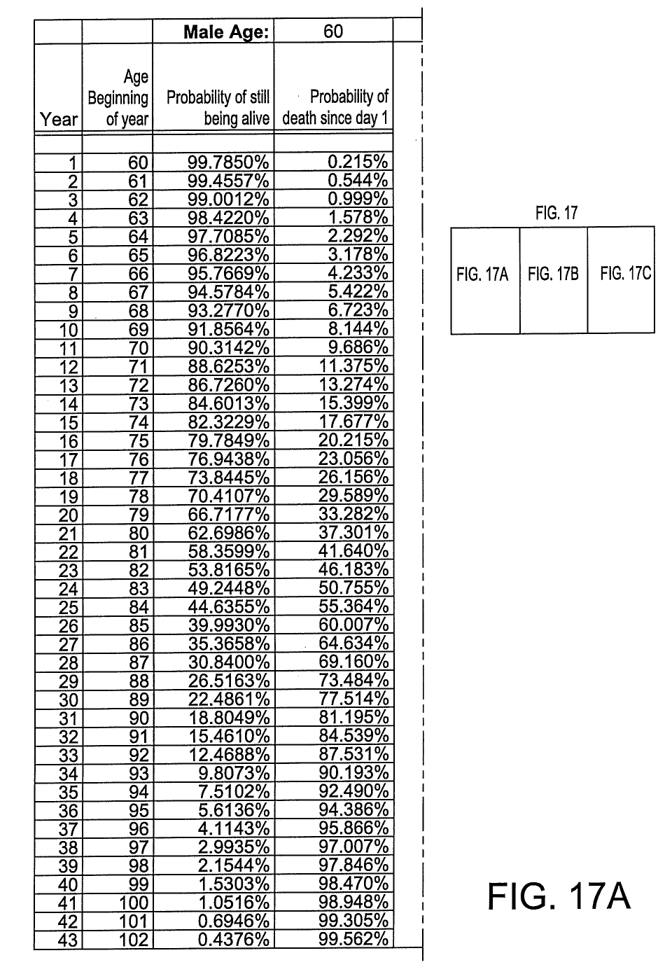

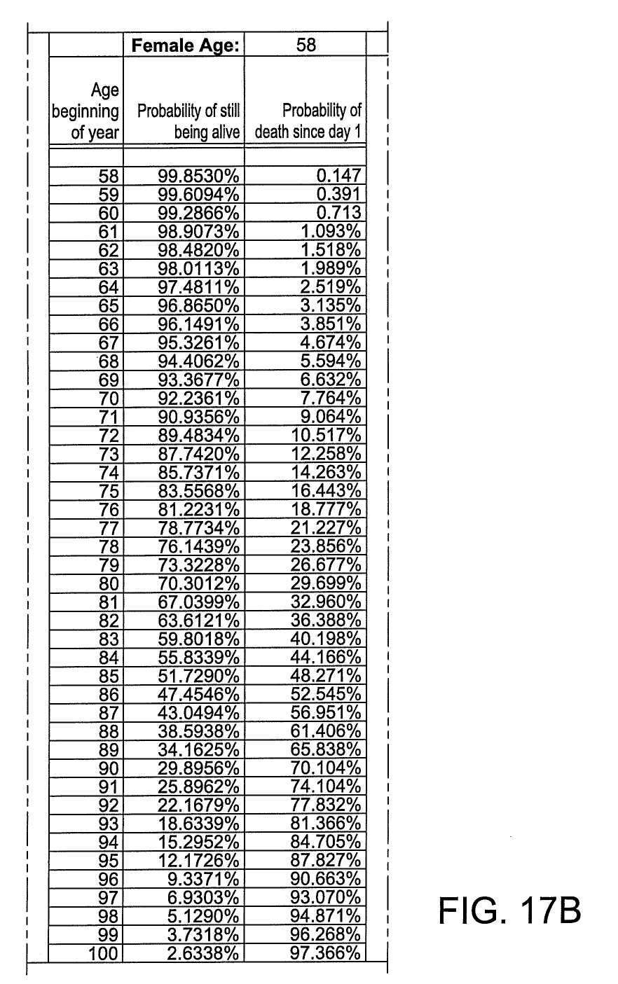

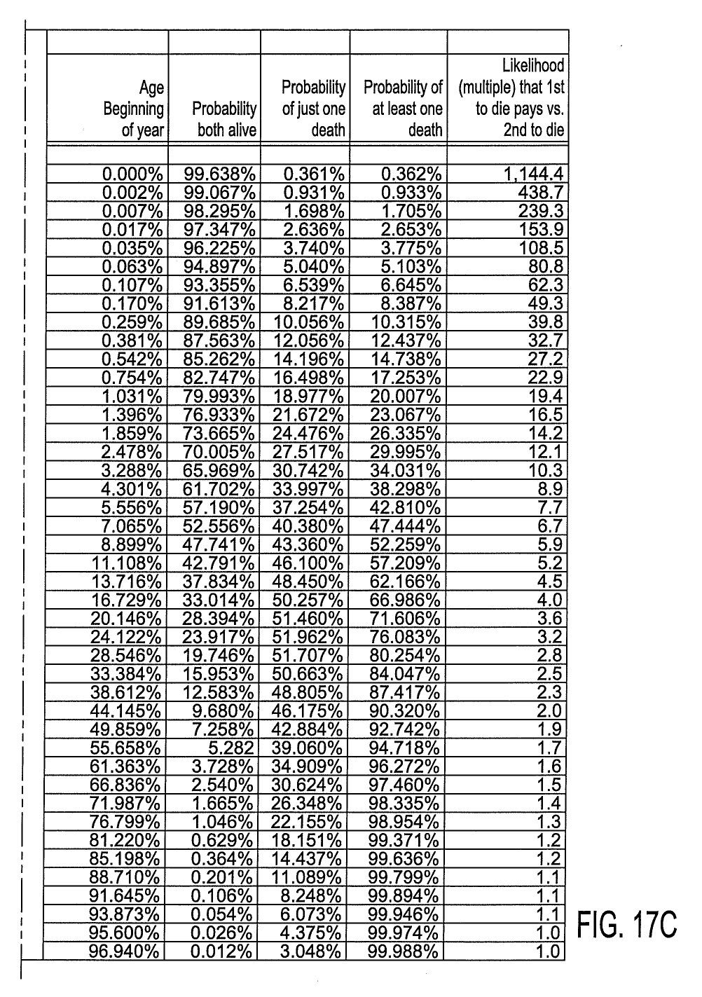

Referring now to FIG. 17, one may ascertain that joint life expectancy for the above husband and wife is about 31 years. One may then ascertain that it is statistically expected that the Second to Die Life Insurance will not pay until 31 years after purchase. Certain embodiments of the present invention utilize this statistical pay date as an evaluation point.

In the subject exemplary embodiment, the estate may thus be evaluated at year 31. In such a case, the above described traditional approach represents a statistical failure. Indeed, in this example such a traditional approach has less than 1/1,000 of a percent chance of actually working as designed.

For example, the subject embodiment will assume a growth of 5%:

| | | 5% growth to life |
|---|---|---|
| | Today | Expectancy |
| Gross Estate | $20,000,000 | $90,760,790 |
| Estate Tax | ($11,000,000) | ($49,918,434) |
| Securities | $5,000,000 | $18,152,158 |
| Insurance | $6,000,000 | $31,766,276 |
| Needed | | |

Assuming a joint life expectancy of 31 years, and failing to account for life expectancy and probability utilizing a traditional approach leads to an expected shortfall of $25,766,276 ($31,766,276-$6,000,000). Thus, the traditional approach results in an estate plan that is a statistical failure. According to certain embodiments of the present invention, growth of the taxable estate may be taken into account, to provide a more statistically proper estate plan, in conjunction with an insurance program that works in the event of a premature death.

The following further relies upon an assumption that the estate plan is split into separate sections based upon the separate life expectancies of each spouse. While, in the interest of brevity, the following discussion does not delve into details of this strategy which may be referred to as a “two trust approach,” it should be understood that if either spouse lives long enough, their portion of the strategy succeeds. Therefore, the substantially only risk is the premature death of one or both spouses. To better guarantee that the strategy works in any particular case, each spouse is individually insured, such that either or both deaths trigger the payment of insurance proceeds, regardless of the order or timing of the deaths.

As is demonstrated in FIG. 17, the likelihood of individual insurance policies actually paying benefits versus the customarily used Second to Die life insurance, may be characterized as follows:

| | |
|---|---|
| Year 1 | 1,144 to one |
| Year 5 | 108 to one |
| Year 10 | 33 to one |
| Year 15 | 14 to one |
| Year 20 | 7 to one |
| Year 31 | 2 to one |

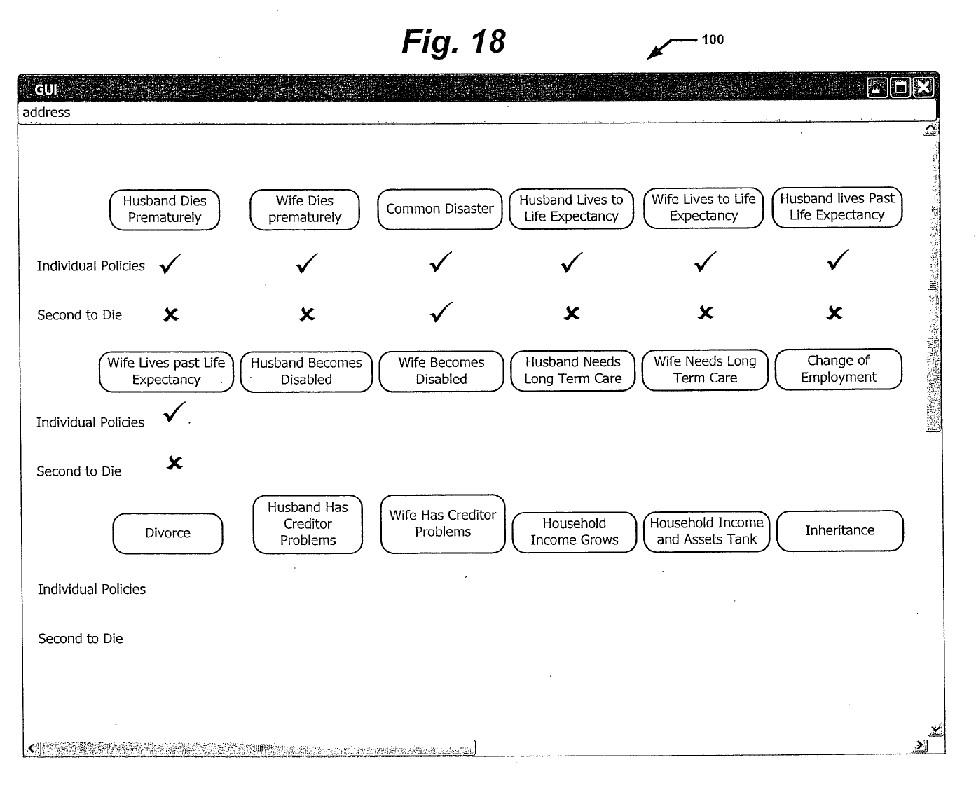

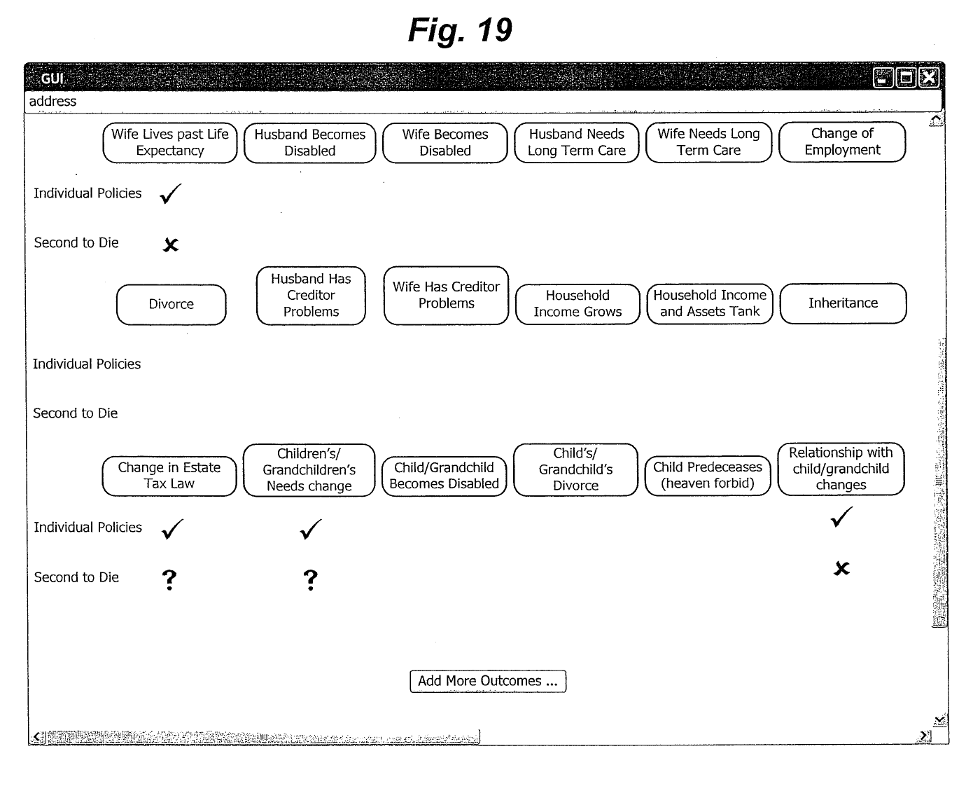

Referring now also to FIGS. 18 and 19 (FIG. 19 illustrates a scrolled-down view of the decision grid or matrix of FIG. 18), there is shown how a corresponding decision grid can provide clear information for financial advisors to make proper recommendations, and customers to make decisions that are in their best interest. FIGS. 18 and 19 compare the Second to Die insurance policy with individual policies like those discussed in the non-limiting preceding example.

By way of further explanation of FIGS. 18 and 19, if the husband dies prematurely an individual life policy pays benefits, even though the corresponding estate planning tool failed. Therefore, the first plan still works. A second to die policy pays no benefits, so the entire second plan fails. If the wife does prematurely, analogous results occur. If there is a common disaster (technically, a premature common disaster) both individual life policies pay benefits, even though the corresponding estate planning tools failed. Therefore, the first plan still works. A second to die policy also pays benefits, such that the second plan still works. If the husband lives to life expectancy, the first plan works, as well as the insurance, even if the wife dies prematurely. The second plan's second to die approach fails, as explained above. If the wife lives to life expectancy, analogous results occur. If either the husband or wife lives past life expectancy, analogous results occur.

Where a change in estate tax law occurs, because the first plan's “two trust solution” permits the spouses to be trustees of the respective trusts created, they (the respective spouses) have considerable flexibility to withdraw principal from the trusts, or to re-allocate the benefits among the class of the trust beneficiaries, e.g., children, grandchildren, trusts, and/or charities, as needs change. The second plan second to die trust will have neither spouse as a trustee, eliminating any such powers. It is questionable whether the actual trustees will have the powers or willingness to exercise such powers if they did, in fact, exist. Where any children's and/or grandchildren's needs change, analogous, results occur. Where any relationship changes with children and/or grandchildren analogous results occur.

Accordingly, the decision grid embodied by FIGS. 18 and 19 facilitates estate planning by clearly and concisely demonstrating deficiencies of a traditional estate plan, while simultaneously demonstrating advantages of a two trust approach. Other plans may be analogously compared.

Referring again to FIG. 17, in response to a general difficulty in otherwise determining probability and therefore expected return under multiple scenarios in order to properly advise customers, underlying data may be based on any statistically relevant baseline, such as the 1991-1995 Society of Actuaries Intercompany Mortality Study, in order to compare probability of events under multiple different scenarios. Embodiments of the present invention thus provide unique decision information, combined with what is considered to be an advantageous formatting, in order to be efficiently used by financial advisors and -their clients. Such a matrix or grid may be provided in a spreadsheet application, such as Microsoft Excel. It is expected that this tool, which is currently in its basic form, can serve as a foundation for significant expansion in the provision of relevant information and understanding to financial advisors and their clients.

Such a system and application may be embodied in computer code stored in a tangible medium and being executable utilizing a computing device. For non-limiting purposes of explanation only, “computing device”, as referred to herein, refers to a general purpose computing device that includes a processor. “Processor”, as used herein, refers generally to a device including a Central Processing Unit (CPU), such as a microprocessor. A CPU generally includes an arithmetic logic-unit (ALU), which performs arithmetic and logical operations, and a control unit, which extracts instructions (e.g., the code) from memory and decodes and executes them, calling on the ALU when necessary. “Memory”, as used herein, generally refers to one or more devices capable of storing data, such as in the form of chips. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including the processor. Memory may be internal or external to the computer. Such memory may store a computer program, e.g., code or a sequence of instructions being operable by the processor. One type of computer executable code typically stored in memory so as to be executable by an Internet enabled computer is a browser application. For non-limiting purposes of explanation only, “browser” as used herein generally refers computer executable code used to locate, display and access web pages. Commercially available browsers include Microsoft Internet Explorer, Netscape Navigator, Apple Safari and Firefox, which all support text, graphics and multimedia information, including sound and video (sometimes through browser plug-in applications).

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

What is claimed is:

1. A tangible computer-readable medium having stored thereon, computer-executable instructions that, if executed by a system, cause the system to perform a method comprising:
receiving information indicative of a plurality of financial related plans;
receiving information indicative of a plurality of future events; and
presenting a visual matrix including additional information about each of the plurality of financial plans, based at least in part upon a product of a probability of at least one of the plurality of future events occurring and a return of each of the financial related plans if the at least one of the future events occurs.

2. The medium of claim 1, wherein the additional information comprises quantitative values.

3. The medium of claim 1, wherein the additional information comprises qualitative indicators.

4. The medium of claim 1, wherein the additional information comprises quantitative values and qualitative indicators.

5. The medium of claim 1, wherein the received information indicative of a plurality of future events comprises quantitative values.

6. The medium of claim 1, wherein the received information indicative of a plurality of future events comprises qualitative indicators.

7. The medium of claim 1, wherein the received information indicative of a plurality of future events comprises quantitative values and qualitative indicators.

8. The medium of claim 1, wherein the visual matrix is based at least in part upon products of probabilities of the plurality of future events occurring and returns of each of the financial related plans if the future events occur, respectively.

9. The medium of claim 1, wherein the visual matrix includes rows indicative of the plurality of financial related plans, respectively.

10. The medium of claim 9, wherein the visual matrix includes columns indicative of the future events, respectively.

11. A method for aiding financial planning, comprising:
inputting information indicative of a plurality of financial related plans to a computing system;
inputting information indicative of a plurality of future events to a computing system; and
providing a visual matrix including additional information about each of the plurality of financial plans, based at least in part upon a product of a probability of at least one of the plurality of future events occurring and a return of each of the financial related plans if the at least one of the future events occurs.

12. The method of claim 11, wherein at least one of the information indicative of a plurality of future events and the additional information comprises quantitative values.

13. The method of claim 11, wherein at least one of the information indicative of a plurality of future events and the additional information comprises qualitative indicators.

14. The method of claim 11, wherein at least one of the information indicative of a plurality of future events and the additional information comprises quantitative values and qualitative indicators.

15. The method of claim 11, wherein the visual matrix is based at least in part upon products of probabilities of the plurality of future events occurring and returns of each of the financial related plans if the future events occur, respectively.

16. The method of claim 11, wherein the visual matrix includes rows indicative of the plurality of financial related plans, respectively.

17. The method of claim 16, wherein the visual matrix includes columns indicative of the future events, respectively.
